(19) United States
(12) Patent Application Publication
(10) Pub. No.: US 2007/0269544 A1
(43) Pub. Date: Nov. 22, 2007

(54) Devices and methods for contouring a shape of an implant that is positioned within a patient

(75) Inventors: David R. Erickson, Memphis, TN (US); Wilder Companioni, Cordova, TN (US)

Correspondence Address: COATS & BENNETT, PLLC, 1400 Crescent Green, Suite 300, Cary, NC, 27518, US

(73) Assignee: SDGI Holdings, Inc.

(21) Appl. No.: 11/392,031

(22) Filed: Mar. 29, 2006

(51) Int. Cl. B28B 1/00

(52) U.S. Cl. 425/2

(57) ABSTRACT

The present application is directed to devices and methods for contouring an implant. The implant is constructed of a material that is moldable when heated above a glass transition temperature. The devices and methods provide for applying heat while the implant is within the patient. The temperature of the implant or a section of the implant is elevated above the glass transition temperature to contour the implant to the desired shape. Once contoured, the devices and methods include removing the heat causing the implant to cool below the glass transition temperature to a substantially solid state. In various embodiments, the devices generally include a body, a contact section positioned on the body, and a heater that heats the contact section.

### BACKGROUND

The present application is directed to devices and methods for contouring an implant and, more specifically, to devices and methods that apply heat to contour the shape of the implant while the implant is positioned within a patient.

Implants are attached at various locations throughout the body. The implants may comprise a variety of configurations, shapes, and sizes including plates, spacers, rods, supports, etc. The implants are normally constructed of a substantially rigid material to perform their intended function. The implants are normally attached and/or positioned within the body to bone. The implants are attached in a variety of manners including fasteners, tethers, adhesives, etc.

The implants should be shaped to conform to the bone and/or the anatomy where they are attached, similar to maxilo-facial plates. If the shape of the implants does not match, proper attachment may be difficult and additional procedures to correct the problem may be required at a later time. Further, improper shape may cause an uneven force distribution once the implant is attached to the bone. This may result in failure of the implant, failure of the bone, or both. A poorly shaped implant may also interfere with other internal members which may cause damage to the patient.

Some implants are shaped and sized to match the anatomy prior to attachment within the body such as plate benders. This may require carefully measuring of the anatomy prior to attachment and then specifically constructing the implant to match the measured sizes. This may also require the availability of multiple implants each having a different size. Each of the different implants is considered and the nearest match is used for the patient. In both instances, the implants may not accurately match the anatomy.

### SUMMARY

The present application is directed to devices and methods for contouring an implant while positioned within a patient. The implant may be constructed of a material that is moldable when heated above a glass transition temperature. The devices and methods provide for applying heat while the implant is within the patient. In one embodiment, the temperature of the implant or a section of the implant may be elevated above the glass transition temperature to contour the implant to the desired shape. Once contoured, the devices and methods may include removing the heat causing the implant to cool below the glass transition temperature to a substantially solid state. In one embodiment, the heated section of the devices may be heated by an external source prior to insertion within the patient.

### BRIEF DESCRIPTION OF THE DRAWINGS

FIG. 1 is a schematic view illustrating a contouring tool according to one embodiment.

FIG. 2 is a schematic view illustrating a contouring tool according to one embodiment.

FIG. 3 is a schematic view illustrating a contouring tool according to one embodiment.

FIG. 4 is a perspective view illustrating a contouring tool according to one embodiment.

FIG. 5 is a schematic view illustrating a contouring tool according to one embodiment.

FIG. 6 is a partial schematic view illustrating a contouring tool according to one embodiment.

FIG. 7 is a perspective view illustrating a contact section according to one embodiment.

FIG. 8 is a schematic diagram illustrating a heater according to one embodiment.

FIG. 9 is a schematic view illustrating a contouring tool according to one embodiment.

FIG. 10 is a schematic view illustrating a heating unit according to one embodiment.

FIG. 11 is a schematic view illustrating a heating unit according to one embodiment.

FIGS. 12A-C are schematic views illustrating a method of using a contouring tool according to one embodiment.

FIG. 13 is a schematic view illustrating a contact section according to one embodiment.

FIG. 14 is a cross section view of a contouring tool and attached implant according to one embodiment.

FIG. 15 is a schematic view of an implant according to one embodiment.

### DETAILED DESCRIPTION

The present application is directed to devices and methods for contouring an implant. In one embodiment, the implant may be constructed of a material that is moldable when heated above a glass transition temperature. The devices and methods provide for applying heat while the implant is within the patient. The temperature of the implant or a section of the implant is elevated above the glass transition temperature to contour the implant to the desired shape. Once contoured, the devices and methods include removing the heat causing the implant to cool below the glass transition temperature to a substantially rigid state. The heated section of the devices may be heated while inserted within the patient, or prior to be inserted within the patient.

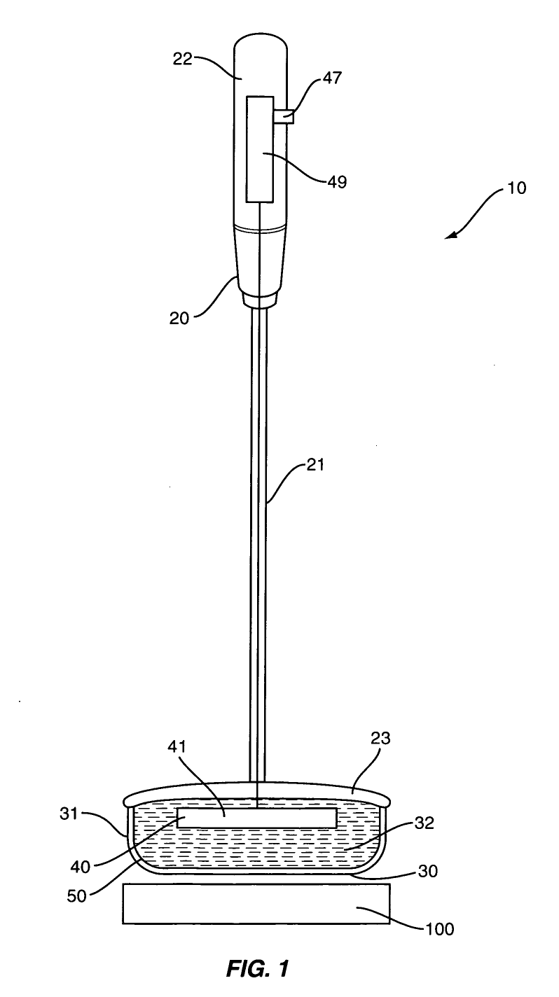

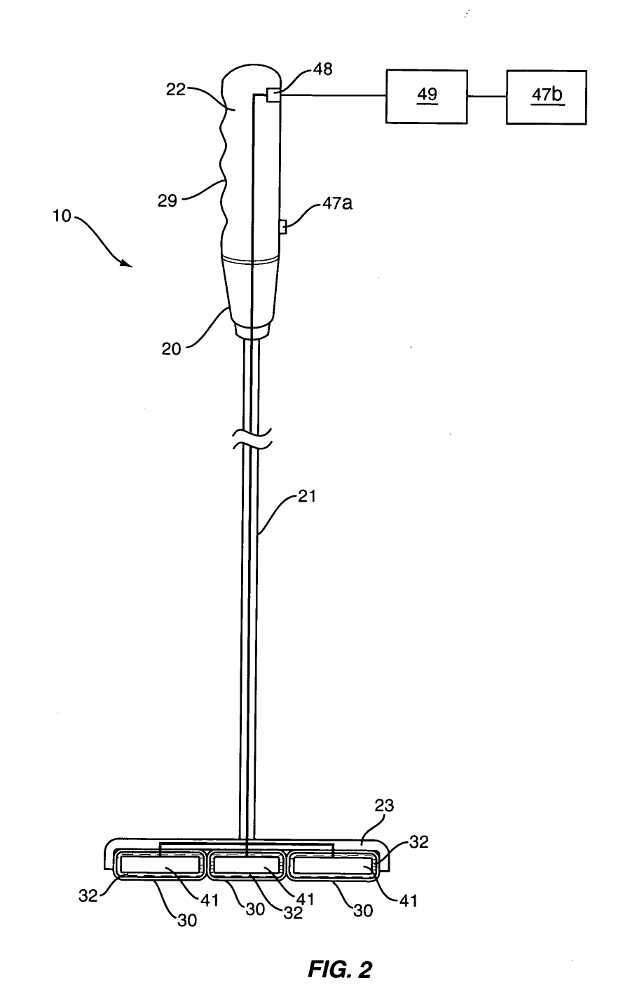

FIG. 1 illustrates one embodiment of a device generally illustrated as element 10. In this embodiment, device 10 includes a body 20 comprising an elongated neck 21 and a handle 22. The neck 21 may have a variety of lengths depending upon the application. In one embodiment, neck 21 has a length for the handle 22 to remain on an exterior of the patient when the contact section 30 abuts against the implant 100. In one embodiment as illustrated in FIGS. 1 and 2, the neck 21 is substantially straight. In other embodiments, neck 21 may be curved.

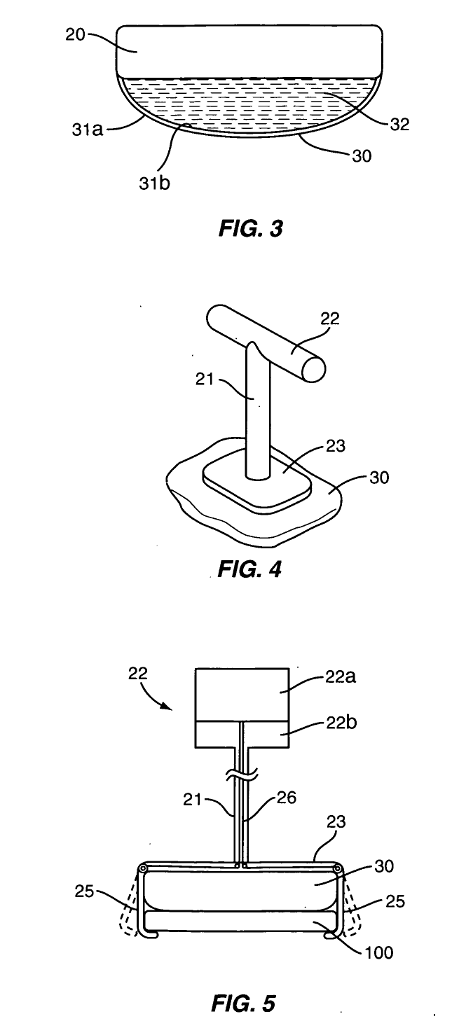

Handle 22 may be sized to be grasped and manipulated by the surgeon. In one embodiment, the handle 22 may include grips 29 as illustrated in FIG. 2 to facilitate this function. Handle 22 may further include a textured or knurled surface to prevent slipping. In one embodiment as illustrated in FIGS. 1 and 2, handle 22 is connected to a proximal end of the neck 21. Handle 22 may further be positioned at other locations on the neck 21. FIG. 3 illustrates an embodiment with the body 20 including a single section that functions as both a gripping surface and a support for the contact section 30. In this embodiment, body 20 may not include a neck 21.

Body 20 may further include a support 23 to support the contact section 30. Support 23 may have a variety of shapes and sizes. FIG. 1 illustrates an embodiment including a curved longitudinal shape, with FIG. 2 illustrating an embodiment including a substantially flat shape. In one embodiment, support 23 extends substantially along one side of the contact section 30 as illustrated in the embodiments of FIGS. 1 and 4. In one embodiment as illustrated in FIG. 2, support 23 extends substantially along three sides of the contact section 30. In one embodiment, support 23 is larger than and extends beyond the contact section 30. In one embodiment, support 23 is substantially the same size as the contact section 30. In one embodiment as illustrated in FIG. 4, support 23 is smaller than the contact section 30.

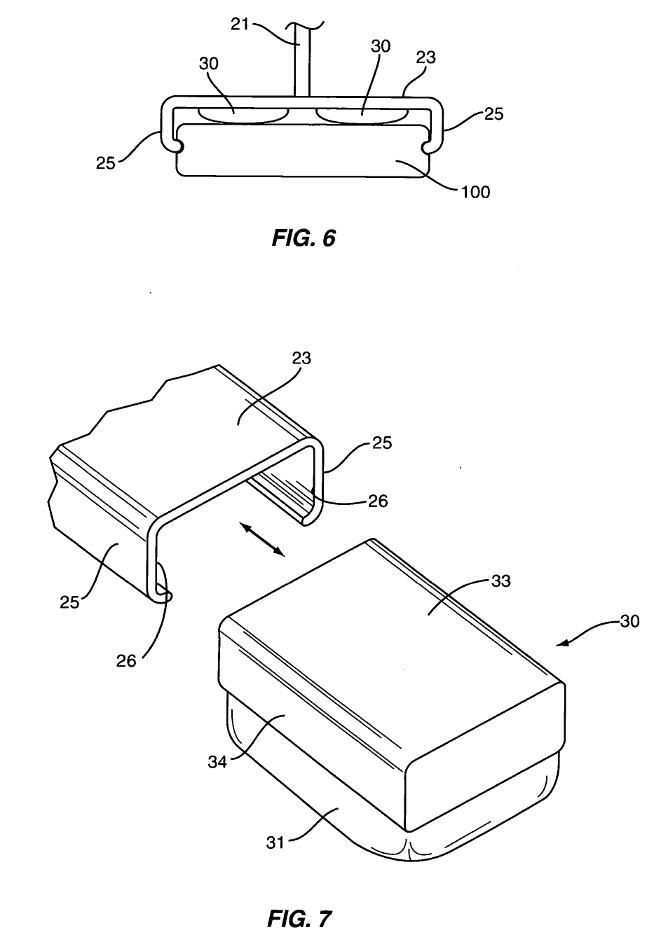

In one embodiment, the body 20 is configured to attach with the implant 100. The body 20 may then be used for positioning the implant 100 within the patient, in addition to abutting the contact section 30 against the implant 100. FIG. 5 illustrates one embodiment with the support 23 including one or more arms 25. Arms 25 extend from the support 23 and are shaped and sized to maintain attachment with the implant 100. In the embodiment of FIG. 5, arms 25 are movably mounted to the support 23 at a first position as illustrated in solid lines to attach the implant 100. Arms 25 may also be movable to a second position as illustrated in dashed lines to detach the implant 100. The embodiment of FIG. 5 features two separate arms 25. In other embodiments, more than two arms 25 may be used to attach the implant 100. The embodiment of FIG. 5 further includes each of the two arms 25 being movable to detach the implant 100. In other embodiments, fewer than all the arms 25 are movable. In one embodiment, arms 25 are configured to extend along an underside of the implant 100 as illustrated in FIG. 5. In one embodiment, arms 25 contact an edge of the implant 100 during attachment as illustrated in FIG. 6.

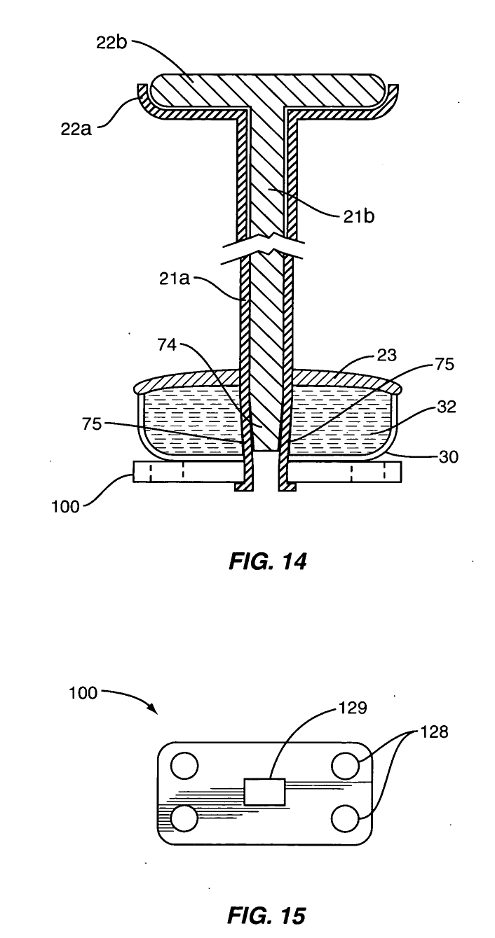

FIGS. 14 and 15 illustrate an embodiment that attaches to the implant 100. An interior member includes a neck 21b with a handle 22b at the proximal end. The distal end of the neck 21b tapers to a smaller distal end. The interior member fits within an exterior member that includes a handle 22a and a neck 21a. The neck 21a is operatively connected to the support 23 and includes fingers that mate with a plate holding feature 129 in the implant 100. The exterior neck 21a may be constructed of a flexible material such that the fingers can move inward and outward. When the interior member is positioned within the exterior member as illustrated in FIG. 14, the tapered end of the neck 21b causes the fingers to move outward and engage the plate holding feature 129. The interior member may further be moved in a proximal direction with the tapered end moving away from the fingers and causing the fingers to move inward and disengage from the plate holding feature 129. This embodiment may include a single contact section 30 that extends around the neck 21a, or may include two or more separate contact sections 30.

In one embodiment, arms 25 are operatively connected to the handle 22. Manipulation of the handle 22 may move the arms 25 between the attached and detached positions. In one embodiment as illustrated in FIG. 5, handle 22 includes a first section 22a and a second section 22b. A linkage 26 extends between the handle 22 and the arms 25. Rotation of the first section 22a relative to the second section 22b moves the linkage 26 causing the arms 25 to move between the attached and detached positions. In one embodiment, relative rotation of the first section 22a in a first direction (e.g., clockwise) relative to the second section 22b causes one or more of the arms 25 to move in a first direction, and relative rotation in a second direction causes one or more of the arms 25 to move in a second direction.

The contact section 30 is attached to the body 20. In one embodiment, contact section 30 comprises an exterior membrane 31 and an interior material 32. In one embodiment, membrane 31 extends completely around the material 32. In another embodiment, membrane 31 extends partially around the material 32 with the body 20 extending around the remainder.

In one embodiment, membrane 31 is constructed of a flexible material that may deform during contact with the implant 100. The membrane 31 may be elastic or may be inelastic. Membrane 31 may be constructed from a variety of materials, including but not limited to silicone, silicone rubber, polyeurathane, polyester, nylon, polytetrafluoroethylene, and polyester.

Membrane 31 may further be constructed of a combination of different materials. FIG. 9 illustrates one embodiment with the membrane 31 constructed of a first material 37 and a second material 38. In one embodiment, the first material 37 has a different stiffness than the second material 38. In one embodiment, first material 37 is substantially rigid and inflexible and second material 38 is a flexible material.

In one embodiment as illustrated in FIG. 1, the contact section 30 includes a single membrane 31. In another embodiment, two or more membranes 31 are placed in an overlapping arrangement forming multiple plies that contain the material 32. FIG. 3 illustrates an example with a first exterior membrane 31a and a second interior membrane 31b. Multiple membranes 31 may be constructed of the same or different materials. In one embodiment, material 32 is positioned between the multiple membranes 31. In another embodiment, the multiple membranes 31 are in contact.

Material 32 is viscoelastic to flexibly support the membrane 31 allowing for the membrane 31 to be shaped as necessary. Material 32 may further position the membrane 31 from the body 20. In one embodiment, material 32 has a viscosity to move throughout the membrane 31. In one embodiment, material 32 has a low viscosity such as a saline solution that freely moves within the membrane. In another embodiment, material 32 has a high viscosity such as silicone gel. In one embodiment, material 32 has substantially the same viscosity regardless of its temperature. In other embodiments, the viscosity of the material 32 changes dependant upon its temperature. A variety of different materials 32 may be used, including but not limited to silicone gel, silicone oil, saline, and polydimethylsiloxane. In one embodiment, material 32 is a combination of two or more different materials. In one embodiment, material 32 completely fills the membrane 31. In another embodiment, material 32 partially fills the membrane 31.

In one embodiment as illustrated in FIG. 1, a frame 50 is positioned within the membrane 31. Frame 50 functions to keep the membrane 31 spaced from the body 20. Frame 50 may extend throughout the spaced formed by the membrane 31, or may be positioned within a limited section of the space.

In one embodiment, contact section 30 is permanently attached to the body 20. A variety of different attachment features may be used such as mechanical fasteners and adhesives. In another embodiment, contact section 30 is removable from the body 20. FIG. 7 illustrates one embodiment with the support 23 comprising arms 25 forming slots 26. Contact section 30 includes the membrane 31 attached to a base 33. Sidewalls 34 along the base 33 are sized to fit within the slots 26 thus allowing the contact section 30 to be attached to the body 20. The removable nature of the contact section 30 may further provide for selecting the desired contact section 30 for the specific contouring task. By way of example, a first contact section 30 including a large membrane 31 may be appropriate for a first contouring task, and a second contact section 30 with a smaller membrane 31 may be appropriate for a second task.

In one embodiment, a heater 40 is positioned to elevate the temperature of the material 32. In one embodiment as illustrated in FIG. 1, heater 40 includes one or more electrothermal elements 41 positioned within the space formed by the membrane 31. The elements 41 may include a variety of shapes and sizes. In one embodiment as illustrated in FIG. 9, the body 20 includes a recess 27 in fluid communication with the area formed by the membrane 31. A heating element 41 is positioned within the section 27 to heat the material 32. In this embodiment, the body 20 guards the heating element 41 to prevent possible damage to the heating element 41, and/or contact of the heating element 41 with the membrane 31.

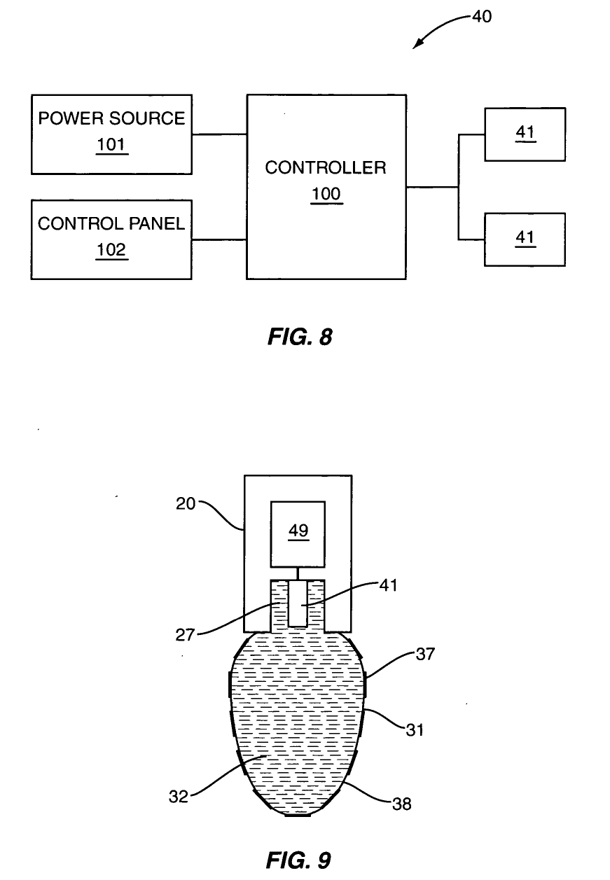

FIG. 8 illustrates a schematic view of a heater 40 according to one embodiment. For ease of description, the heater 40 is divided into the one or more elements 41 and control components 49. In one embodiment, one or more of the control components 49 are housed within the body 20 such as illustrated in FIG. 1. In another embodiment, the control components 49 are exterior to the body 20 and attached through a mount 48 as illustrated in FIG. 2.

Control components 49 may include a controller 100 that oversees the heating operation. In one embodiment, controller 100 includes a microcontroller with associated memory. A power source 101 may comprise any suitable AC or DC power. In one embodiment, power source 101 is a battery sized to be stored within the body 20. Battery may be permanently stored within the body 20, or may be removable for recharging or replacing. In another embodiment as illustrated in FIG. 2, the power source 101 is located outside of the body 20.

Control components 49 may further include a control panel 102 for the operator to control and observe the operation of the heater 40. In one embodiment, control panel 102 includes one or more inputs to adjust the temperature of the elements 41. The inputs may provide for adjusting the temperature higher and lower as necessary. In one embodiment, control panel 102 may include one or more gauges to monitor the temperature of the elements 41 and/or the material 32. In one embodiment, a single gauge provides the temperature of the material 32 within the membrane 31. In another embodiment, multiple gauges provide the temperature of the material 32 within different zones within the membrane 31. Control panel 102 may be positioned on the body 20, on an external device that attaches with the body 20, or a combination of both. In one embodiment, a switch 47 activates and deactivates the heater 40. In one embodiment, the switch 47 is positioned on the body 20. In another embodiment, switch 47 is positioned on the control components 49.

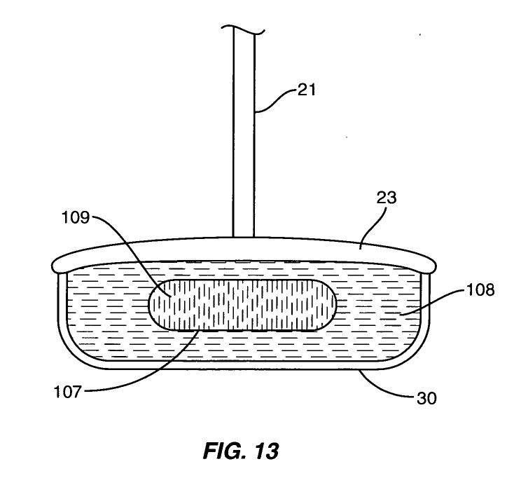

FIG. 13 illustrates an embodiment with the contact section 30 comprising a first material 108 and a second material 109. The materials 108, 109 are physically separated prior to use. In this embodiment, second material 109 is maintained within a sealed container 107 to remain isolated from the first material 108. At the time of use, container 107 is unsealed and first and second materials 108, 109 are mixed together. This causes a chemical reaction that heats the contact section 30 to a predetermined temperature that is above the glass transition temperature of the implant 100. The embodiment of FIG. 13 includes first and second materials 108, 109. Other embodiments may include more than two separate materials that are mixed together.

In one embodiment, the contact section 30 is heated by an external source. The contact section 30 may remain attached to the body 20 during the external heating, or may be removed. In one embodiment, body 20 is constructed of an insulating material such that the heat applied to the contact section 30 is not distributed to the handle 22.

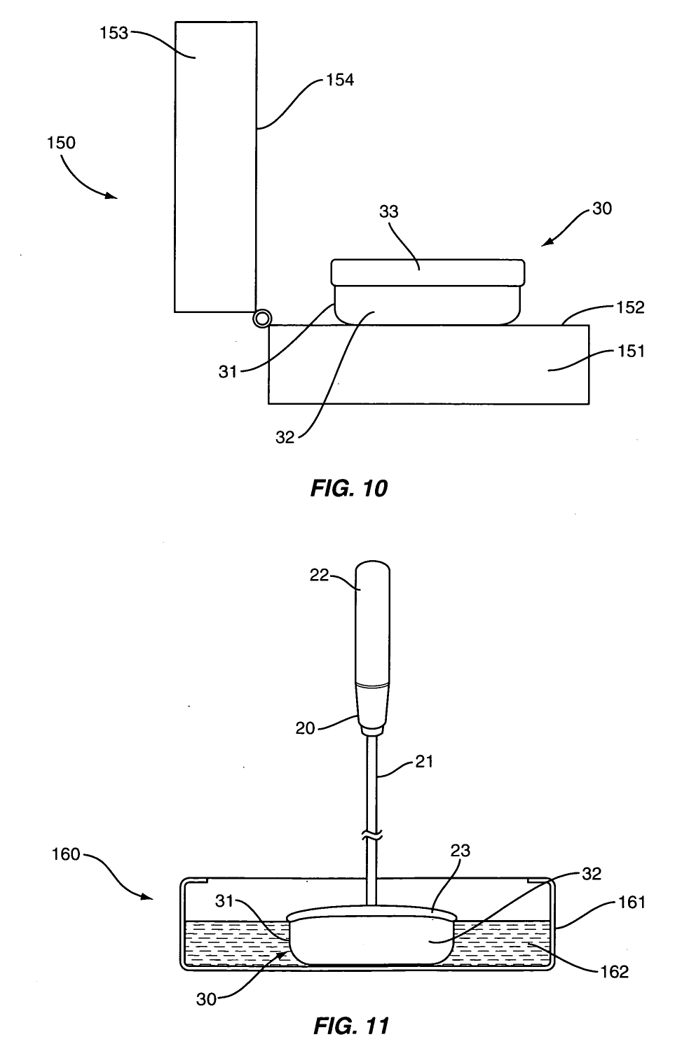

FIG. 10 illustrates one embodiment with the external source comprising a heating unit 150. Heating unit 150 includes a body 150 including a heating surface 152 that can be raised to an elevated temperature. Heating surface 152 is sized to support the contact section 30. In one embodiment, a cover 153 may be movably connected to the body 151 and positionable between an open position as illustrated in FIG. 10, and a closed position that extends over the heating surface 152. In one embodiment, cover 153 includes a heating surface 154 that may contact the contact section 30 when the cover 153 is in the closed position.

FIG. 11 illustrates one embodiment of an external heating source comprising a heating unit 160. Heating unit 160 includes a tank 161 that holds a material 162 that is raised to an elevated temperature. The amount of material 162 may vary. In one embodiment, material 162 covers a portion of the membrane 31. In another embodiment, material 162 completely covers the membrane 31 and a portion of the body 20.

In one embodiment when using an external heating source, the contact section 30 is in a sterile container prior to placement on the external heating source. Once heated, the sterile container may be removed prior to insertion of the contact section 30 into the patient.

In one embodiment, contact section 30 comprises a single fluid containing section. FIG. 1 illustrates one embodiment with a single fluid containing section attached to the body 20. In one embodiment, multiple fluid containing sections are attached to the body 20. FIG. 2 illustrates an embodiment having three separate sections, with FIG. 6 illustrating an embodiment with two separate sections. The sections may include a variety of shapes and sizes, and may be constructed of the same or different materials. In one embodiment with multiple sections, the sections may be independently removable and replaceable.

The heated contact section 30 is placed against the implant 100 to contour the shape. In one embodiment, the implant 100 includes two thermo-chemical solids states. A first state is rigid and the implant 100 will remain at this state at temperatures below a glass transition temperature. In one embodiment, the glass transition temperature is in excess of about 60° Celsius. The implant 100 at the second state is still solid but may be sufficiently deformable to be contoured to the desired shape. After the implant 100 is contoured to the desired shape at the second state, the implant 100 is allowed to cool below the glass transition temperature to transform back to the first state. In some embodiments, the implant 100 is constructed of polyglyconate, polyglycolic acid (PGA), polylactic acid (PLA), primacryl, and trimethylenecarbonate.

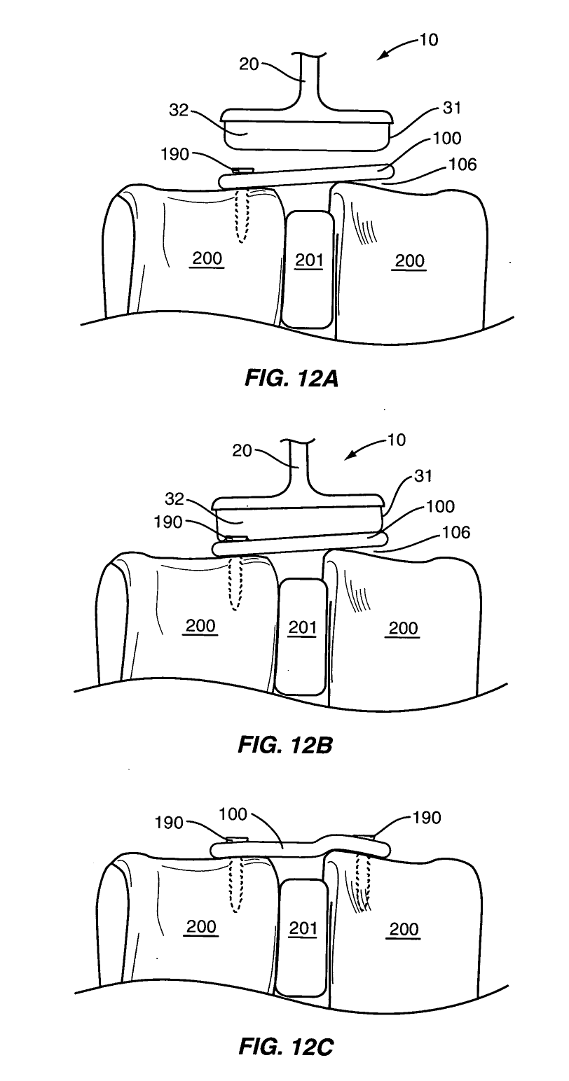

FIGS. 12A, 12B, and 12C illustrate a method of using a contouring tool 10 according to one embodiment. As illustrated in FIG. 12A, an implant 100 has been positioned within a patient. In this specific embodiment, the implant 100 is a vertebral plate that spans across an intervertebral space formed between adjacent vertebral members 200. The implant 100 may be a bioresorbable member. In this embodiment, graft material 201 has been placed within the intervertebral space. Although this embodiment illustrates a use of the contouring tool 10 within the context of a spinal application, the tool 10 may have other applications for implants 100 within other sections of the body.

Returning to FIG. 12A, implant 100 has been positioned within the body with a gap 106 formed between an underside of the implant 100 and one of the vertebral members 200. In this embodiment, a first fastener 190 has been inserted to attach a first section of the implant 100 to the vertebral member 200. In one embodiment, this fastener 190 loosely attaches the implant 100 to the first vertebral member 200. In another embodiment, a second fastener 190 attaches a second section of the implant to the second vertebral member 200 prior to the contouring. In one embodiment, the implant 100 is not attached prior to contouring.

As illustrated in FIG. 12B, the contouring tool 10 is inserted into the body with the contact section brought into contact with the implant 100. As illustrated, the flexible membrane 32 deforms upon the contact and may conform to the shape of the implant 100. The contact section 30 may be heated to an elevated temperature prior to contact with the implant 100, or may be heated after the contact. Once the contact section 30 is heated towards an elevated temperature, the contact elevates the temperature of the implant 100 above its glass transition temperature. Once above this temperature, the implant 100 may be contoured to match the necessary shape. As illustrated in FIG. 12B, the implant 100 is bent towards the vertebral member 200 to remove the gap 106 and substantially match the outer surface of the vertebral members 200. Tool 10 may further provide a means for applying pressure to the implant 100 to facilitate the contouring. The surgeon may grasp the body 20 and apply a force through the contact section 30. In one embodiment, the higher the temperature of the implant 100 is raised above its glass transition temperature, the less force is necessary for contouring.

After the implant 100 has been contoured, the tool 10 is removed and the implant 100 cools to below the glass transition temperature. In one embodiment, fasteners 190 are inserted or further tightened to fixedly attach the implant to the vertebral members 200.

The term “distal” is generally defined as in the direction of the patient, or away from a user of a device. Conversely, “proximal” generally means away from the patient, or toward the user. Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. In one embodiment, the body 20 does not include a support 23 and the contact section 30 is connected to the neck 21 or the handle 22. The present embodiments are, therefore, to be considered in all respects as illustrative and not restrictive, and all changes coming within the meaning and equivalency range of the appended claims are intended to be embraced therein.

What is claimed is:

1. A device to contour an implant positioned within a patient, the device comprising:
a body; and
a contact section attached to the body and comprising a viscoelastic material contained by a flexible membrane, the material spacing a contact surface of the membrane away from the body to be deformable to conform to a shape of the implant;
the material and the flexible membrane being constructed to be heated to an elevated temperature above a glass transition temperature of the implant.

2. The device of claim 1, wherein the membrane comprises multiple plies including at least a first layer and a, second layer.

3. The device of claim 1, further comprising fastening means for permanently fastening the contact section to the body.

4. The device of claim 1, wherein the flexible membrane extends completely around the material.

5. The device of claim 1, further comprising a second contact section attached to the body and positioned in proximity to the contact section.

6. The device of claim 1, wherein the contact section is removably attached to the body.

7. The device of claim 1, further comprising a thermoelectric heating element positioned within the contact section to heat the material to the elevated temperature.

8. The device of claim 7, further comprising a power source positioned within the body and being operatively connected to the heating element.

9. The device of claim 8, further comprising a controller positioned within the body to oversee the operation of the heating element.

10. The device of claim 7, further comprising a control adjustment mechanism operatively connected to the controller and positioned on the body to control a temperature of the heating element.

11. The device of claim 1, further comprising a frame positioned within the contact section to maintain the contact surface of the membrane spaced away from the body.

12. The device of claim 1, wherein the material is selected from the group consisting of silicone gel, silicone oil, saline, and polydimethylsiloxane.

13. The device of claim 1, further comprising arms that extend outward from the body to attach with the implant, the arms positioned to maintain the implant in contact with the contact section.

14. The device of claim 13, wherein the arms are movably positioned between a first position to attach with the implant and a second position to separate the body from the implant.

15. A device to contour an implant comprising:
a body;
a flexible membrane attached to the body and including a contact surface; and
a viscoelastic material positioned between the body and the flexible membrane, the material maintaining the contact surface of the membrane spaced away from the body and supporting the contact surface to be deformable to conform to a shape of the implant.

16. The device of claim 15, wherein the membrane extends around an entirety of the material.

17. The device of claim 15, wherein the membrane is permanently attached to the body.

18. The device of claim 15, further comprising a heater to heat the material.

19. The device of claim 15, further comprising a container that contains a second material positioned within the material, the container physically separating the material and the second material.

20. A device to contour an implant comprising:
a body; and
a contact section attached to the body and comprising a viscoelastic material that supports a contact surface of the membrane, the material maintaining the contact surface spaced away from the body and being deformable to conform to a shape of the implant; and
a heating element positioned within the contact section to heat the material to an elevated temperature.

21. The device of claim 20, wherein the material has a first viscosity at a lower temperature and a second higher viscosity at the elevated temperature.

22. The device of claim 20, further comprising a power source operatively connected to the heating element and positioned within the body.

23. The device of claim 20, further comprising a second contact section attached to the body, the second contact section comprising a second heating element.

24. The device of claim 20, further comprising a second heating element positioned within the contact section to heat the material.

25. A method of contouring an implant positioned within a patient, the method comprising the steps of:
heating a viscoelastic material contained within a flexible membrane from a first temperature to an elevated second temperature;
contacting the flexible membrane against the implant;
heating the implant towards the second temperature by the contact with the flexible membrane;
contouring the implant to a desired shape; and
removing the flexible membrane from against the implant and causing the implant to cool.

26. The method of claim 25, wherein the step of heating the material to the elevated second temperature comprises heating the flexible membrane and the material with an external source and then inserting the flexible membrane and the material into the patient.

27. The method of claim 25, wherein the step of heating the material to the elevated second temperature comprises mixing a second material positioned within the flexible membrane with the material.

28. The method of claim 25, wherein the step of heating the material to the elevated second temperature occurs while the membrane and the material are positioned within the patient.

29. The method of claim 25, wherein the step of contacting the flexible membrane against the implant comprises deforming the flexible membrane to correspond to a shape of the implant.

30. The method of claim 25, wherein the step of contacting the flexible membrane against the implant comprises applying a contouring force through the material and the membrane to the implant.

31. The method of claim 25, wherein the implant comprises a spinal plate.

32. The method of claim 25, wherein the implant comprises a bioresorbable plate.

33. The method of claim 25, wherein the step of contouring the implant to a desired shape comprises substantially matching the outer surface of two adjacent vertebral members.

34. A method of contouring an implant positioned within a patient, the method comprising the steps of:
heating a flexible membrane;
contacting the flexible membrane against the implant and deforming a shape of the membrane;
heating the implant above a glass transition temperature by the contact with the flexible membrane;
contouring the implant to a desired shape while the implant is above the glass transition temperature; and
removing the flexible membrane from against the implant causing the implant to cool below the glass transition temperature.

35. The method of claim 34, wherein the step of heating the flexible membrane comprises heating a material that is in contact with the flexible membrane.

36. A method of contouring an implant positioned within a patient, the method comprising the steps of:
heating a viscoelastic material contained within a membrane;
contacting the flexible membrane against the implant and deforming the membrane;
heating the implant above a glass transition temperature by the contact with the flexible membrane;
applying a force to the implant while the implant is above the glass transition temperature and contouring the implant to a desired shape; and
removing the flexible membrane from against the implant causing the implant to cool below the glass transition temperature.

37. The method of claim 36, further comprising removing the flexible membrane from a body and attaching a second flexible membrane to the body.
